(19) United States
(12) Patent Application Publication
(10) Pub. No.: US 2004/0018353 A1
(43) Pub. Date: Jan. 29, 2004

(54) Composite metal foam damping/reinforcement structure

(75) Inventors: Michael J. Czaplicki, Rochester, MI (US); David Carlson, Rochester Hills, MI (US); Kevin Hicks, Harrison Township, MI (US)

Correspondence Address: DOBRUSIN & THENNISCH PC, 401 S OLD WOODWARD AVE, SUITE 311, BIRMINGHAM, MI, 48009, US

(73) Assignee: L&L Products, Inc., Romeo, MI (US)

(21) Appl. No.: 10/621,209

(22) Filed: Jul. 16, 2003

Related U.S. Application Data
(60) Provisional application No. 60/398,411, filed on Jul. 25, 2002.

(51) Int. Cl. B32B 3/26

(52) U.S. Cl. 428/304.4

(57) ABSTRACT

An improved damping or reinforcement structure and method of making the same, comprising a wall of a first material, a layer of adhesive bonded to the first material, and a layer of a metal foam bonded to the viscoelastic adhesive.

### CLAIM OF BENEFIT OF FILING DATE

The present application claims the benefit of the filing date of U.S. Provisional Application Serial No. 60/398,411 (filed Jul. 25, 2002), hereby incorporated by reference.

### TECHNICAL FIELD

The present invention relates to reinforcement or damping structures and particularly to the use of such structures to reinforce an automotive vehicle structure or to otherwise improve the noise, vibration or harshness (NVH) characteristics of an automotive vehicle.

### BACKGROUND

There is a need in the field of reinforced structures, such as in the construction and transportation industries for improved alternatives for enhancing structural reinforcement, damping, thermal insulation and acoustic absorption characteristics. This is particularly acute in the manufacture of automotive vehicles.

By way of example, though like effects are exhibited elsewhere in an automotive vehicle (and the present invention is likewise applicable to address these effects), in some vehicles, there is a particular need for enhancing structural reinforcement, damping, thermal insulation and acoustic absorption characteristics in midgate or bulkhead regions of a vehicle, such as the regions that separate the passenger compartment from the engine compartment or from the cargo area of the vehicle. High levels of engine noise need to be blocked or absorbed by the midgate section so it does not enter the passenger compartment. Further, due to its location, the midgate may need to provide structural support for torsional rigidity, or thermal insulation.

It may also be desirable for such structures to meet various criteria. For example, it may be desirable to afford access to the engine compartment. Also, the ability to use conventional materials to construct the major portions of a vehicle may also be desirable.

There is thus a need to provide desired levels of sound transmission loss, damping, stiffness, and thermal insulation, while preserving the design objectives of minimizing such factors as one or more of weight, cost, component size (in view of limited space available in a vehicle), manufacturing difficulty, installation difficulty, heat transfer, vibrational transfer or the like.

Additional discussion of the needs served by the present invention is provided in “Recent Applications of Viscoelastic Damping for Noise Control in Automobiles and Commercial Airplanes”, by Mohan D. Rao, 2001 India-USA Symposium on Emerging Trends in Vibration and Noise Engineering, the contents of which are incorporated herein by reference for all purposes.

### SUMMARY OF INVENTION

The present invention meets the above needs by providing an improved damping or reinforcement structure, comprising a wall of a first material, and a layer of a metal foam bonded to the wall. The foam is preferably bonded to the wall with a layer or portion of viscoelastic adhesive, a layer or portion of structural adhesive or both. The present invention also provides a method for reinforcing an automotive vehicle. The method preferably comprises the steps of bonding a first adhesive and, optionally, a second adhesive to a wall of a vehicle structure. The method also preferably includes bonding the first adhesive and optionally, the second adhesive to a layer of metal foam. Preferably, the first adhesive is a structural adhesive and the second adhesive is a viscoelastic adhesive.

The present invention can provide up to three and more preferably all of the following advantages and characteristics among others: 1) NVH insulation and damping up to 95 dB; 2) the ability to package the component for a maximum thickness of less than 75 mm, more preferably less than 50 mm (e.g., about 35 mm); 3) a result component mass comparable with the mass of a like component fabricated only from 3 mm thick aluminum; the resulting shear strength, flex strength, stiffness being equal to or greater than the performance would be if the structure were reinforced with 3 mm thick aluminum; 4) provides adequate thermal insulation for the passenger compartment from temperatures up to 350° F. in the engine compartment; and 5) allows access to engine compartment.

Additionally, according to a preferred embodiment, the present invention provides the benefit of a raw metal surface appearance that is cosmetically appealing in many applications, as well as providing a structure that is easy to manufacture and install.

### DESCRIPTION OF THE DRAWINGS

FIG. 1 is a perspective view of a vehicle frame structure.

FIG. 2 is a drawing of an apparatus for acoustical testing.

FIG. 3 is a schematic to illustrate transmission loss in accordance with the present invention.

FIGS. 4a-4c illustrate exemplary performance characteristics obtainable in accordance with the present invention.

FIGS. 5a and 5b illustrate structures useful in the present invention.

FIG. 6 is an illustrative structure of the present invention.

FIG. 6a is also an illustrative structure of the present invention.

FIGS. 7a-d illustrate preferred performance characteristics for the present invention.

The text accompanying the drawings is expressly incorporated by reference herein.

### DETAILED DESCRIPTION

The present invention is predicated upon the provision of a composite structure of an article of manufacture (e.g., an automotive vehicle) wherein the structure typically includes a foam material (e.g., a layer of metal foam) secured to a member (e.g., a metal panel). Preferably, the structure provides improved properties such as improved sound damping or attenuation, improved heat insulation or a combination thereof. In addition, the structure may be able to provide these improved properties along with relatively small dimensions such as relatively low reinforcement thickness.

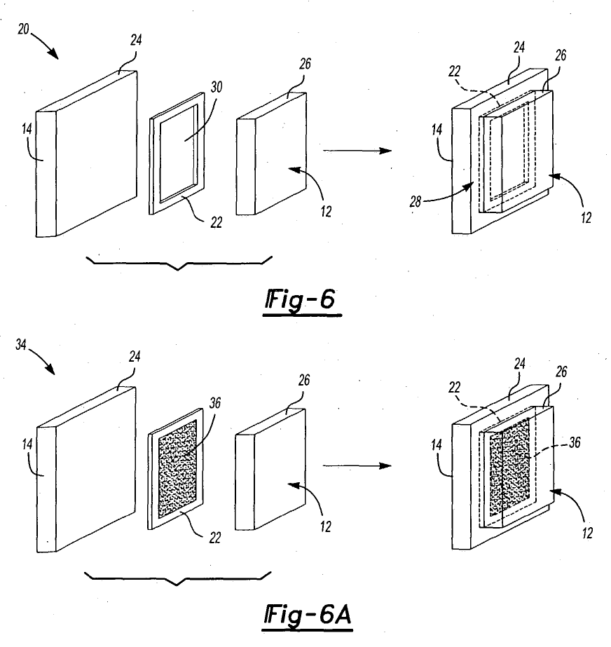

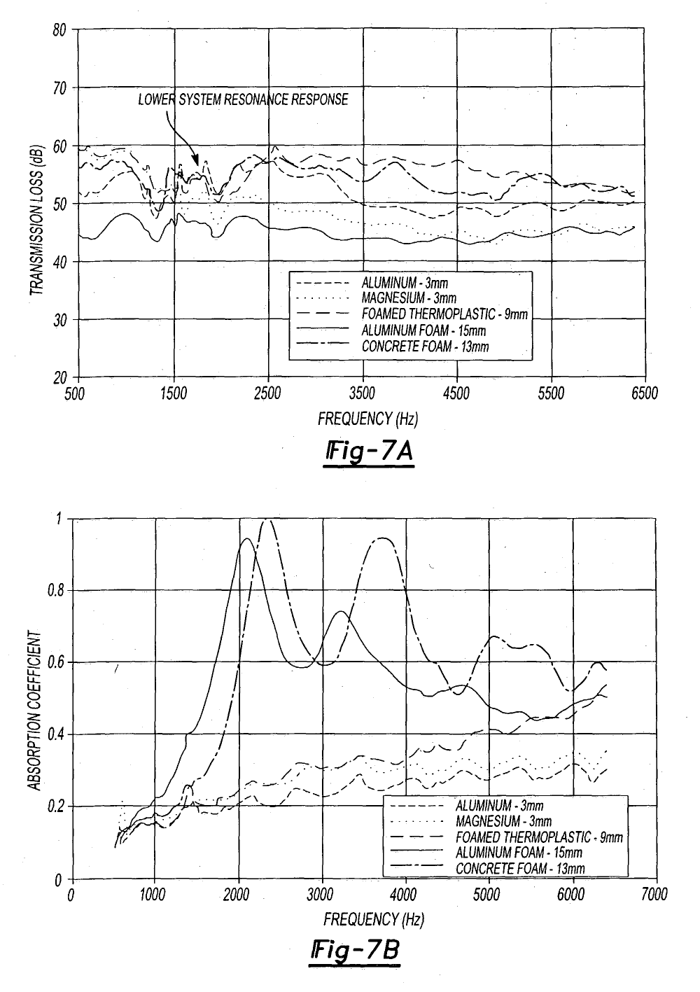

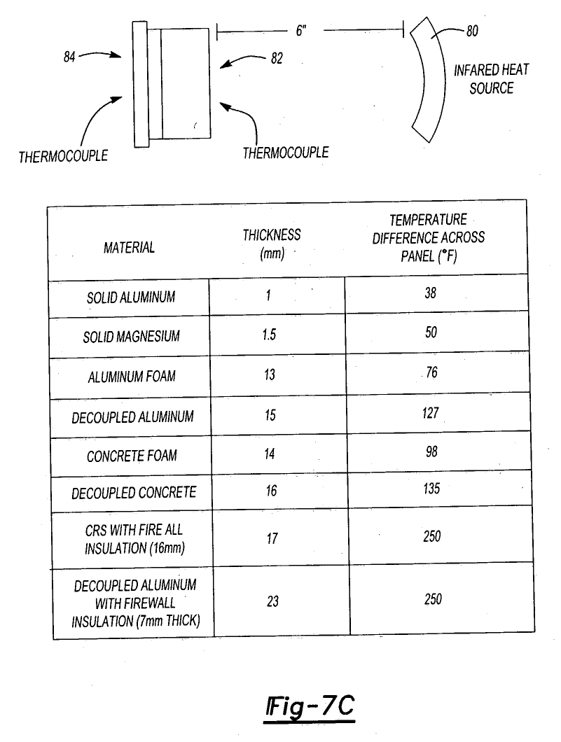

With reference to FIG. 5A and 6, a preferred embodiment utilizes a composite of a metal foam material 12 (e.g., an aluminum foam sheet) adjacent a wall 14 (e.g., of a metal panel) to produce a structure 20 that has superior reinforcement, damping, thermal insulation and acoustic absorption characteristics. Optionally, a structural adhesive 22 may be bonded to the wall 14, the foam material 12 or both to attach the wall 14 to the foam material 12. The metal foam material typically has good acoustic absorption characteristics. The rigidity and thickness of the metal foam preferably reduce the flexural compliance of the wall 14 being reinforced. The adhesive 22, when used, preferably bonds the wall 14 to the foam material 12 for providing increased system stiffness and/or vibrational damping.

The structure of the present invention may include panels or layers that are decoupled relative to each other (i.e., are without substantial direct contact with each other). In the particular embodiment shown, the adhesive 22.is applied as a strip that extends adjacent to a peripheral edge 24 of the wall 14, a peripheral edge 26 of the foam material 12 or both such that a significant amount (e.g., greater than about 30%, more preferably greater than about 50% and even more preferably greater than about 80%) of the space 28 located between the wall 14 and the layer of metal foam material 12 is open space 30. While the strip of adhesive 22 is shown as substantially continuous strip extending about the open space 28, it is to be understood that the strip may be non-continuous and, moreover, may be configured in a variety of alternative shapes and configurations.

In FIG. 6A, there is illustrated another decoupled structure 34 according to the present invention. As shown, the structure 34 is substantially identical to the structure 20 of FIG. 6 with the exception that the open space 30 has been replaced by a viscoelastic adhesive 36 which is shown as a layer that is substantially coplanar with the structural adhesive 22. As shown, the viscoelastic adhesive 36 couples substantially the entirety of the open space 30 an is substantially entirely cirucumscribed by the structural adhesive 22. Thus, the viscoelastic adhesive may occupy the same amount of space between the wall 14 and metal foam material 12 as the open space 30. Of course, the viscoelastic adhesive 22 may only be located in one or more portions of the open space 30 as well.

In FIG. 5B, there is illustrated one exemplary structure 40 having two substantially identical panels 42 which may be attached (e.g., adhesively bonded) to each other such that the panels 42 oppose each other and are substantially coextensive with each other. As shown, the panels 42 are decoupled from each other since they are without direct contact relative to each other over at least a portion of their opposing surfaces. There is also illustrated a structure 50 with a panel 52 of foam material and metal panel 54 wherein the metal panel 54 is adhesively bonded to the panel 52 of foam material with an intermediate viscoelastic layer 56 (e.g., a viscoelastic adhesive that has response characteristics that correspond with that of both an elastic solid and a viscous fluid). It is contemplated that the structure 50 may also include a structural adhesive such as the one described above.

Suitable viscoelastic adhesives for use herein may be selected from epoxies, urethanes, acrylics, vinyls, silicones, rubbers (e.g., butyl rubbers), or the like. In one embodiment, the viscoelastic adhesive is a copolymer of paramethylstyrene and polyisobutylene. Preferably, the viscoelastic adhesive exhibits substantially greater elasticity as compared to any structural adhesive used in the present invention. Advantageously, such an adhesive can reduce vibrations quite efficiently.

In one embodiment, it is preferable for the structural or viscoelastic adhesive to be capable of withstanding the temperatures to which a vehicle is subjected during painting or priming operations (such as temperatures from an electrostatic coating (e-coat) bake operation) It will be appreciated that paint or e-coat ovens are known to reach minimum temperatures of 93.33° C. (200° F.) or greater. Thus, it will be appreciated that the structural adhesive may be heated to a temperature of 93.33° C. (200° F.) or greater. A preferred adhesive is thermally expandable (e.g., from about 5 to about 2000% or higher, more preferably about 10 to about 1000%, and still more preferably at least about 100% volumetrically relative to its original size), at such elevated temperatures, such as from the presence of a blowing agent.

The preferred structural adhesive typically has the characteristics of art-recognized structural adhesives. Preferred structural adhesives exhibit relatively high adhesion characteristics. Preferably, the adhesive adheres to surfaces (e.g., aluminum or electro-coated surfaces) with an adhesion strength greater than 4000 kPa and more preferably with an adhesion strength of greater than 5000 kPa. It is also preferable for the adhesive to exhibit relatively high retention of adhesion strength (e.g., greater than 70%) after exposure to corrosive conditions.

Preferred structural adhesives also exhibit relatively high stiffness characteristics. In one embodiment, the adhesive exhibits stiffness of greater than about 1000 kPa and more preferably greater than about 10,000 kPa between temperatures of about 25° C. to about 70° C. Additionally or alternatively, it is preferable for the adhesive to have a glass transition temperature greater than about 70° C. and more preferably greater than about 80° C. Examples of preferred structural adhesives (e.g., epoxy-based structural adhesives) are disclosed in U.S. patent application Ser. Nos. 60/451,811, filed Mar. 4, 2003; Ser. No. 10/386,287, filed Mar. 11, 2003; Ser. No. 09/974,017, filed Oct. 10, 2001 and U.S. Pat. Nos. 6,296,298; 5,755,486 or 6,150,428 all of which are expressly incorporated herein by reference for all purposes.

Using a decoupled structure may increase the benefit of greater mass or thickness. Having the void between the panel and the reinforcement filled by a viscoelastic layer further increases the benefit by reducing the magnitude of any resonance created by the structure. The cellular structure of the foamed materials increases their insulating properties. Using a polymeric layer further enhances the properties which may allow for less (or no) traditional insulating material to be used. This may allow for a stiffer product within a comparable packaging space. As seen in FIG. 5b, the panels or walls that comprise the structures of the present invention may be the same or a different material, and may be the same or a different size relative to each other.

Referring again to FIGS. 5A and 6 and the exemplary configuration for the decoupled panel structure 20. The metal panel 14 preferably has a substantially uniform thickness that is between about 0.2 mm and about 3.6 mm, more preferably between about 0.5 mm and about 3.0 mm and even more preferably between about 1.0 mm and about 2.0 mm. The adhesive layer 22 is preferably has a substantially uniform thickness of between about 0.3 mm and about 2.7 mm, more preferably between about 0.75 and about 2.25 mm (e.g., about 1.5 mm). The foamed aluminum or concrete layer 12 preferably has a substantially uniform thickness of between about 2.4 mm and about 27.0 mm, more preferably between about 7.5 mm and about 18.0 mm and even more preferably between about 12 mm and about 15 mm.

It should also be appreciated that additional layers may also be employed in the disclosed structures, such as metal foils, fabrics, structural foam (e.g., an epoxy foam such as is disclosed in U.S. Pat. Nos. 6,296,298; 5,755,486; or 6,150,428, hereby incorporated by reference), fibers, wires, acoustical foams, plastic films, veneers or other facings, aramid reinforcements, glass reinforcements or the like.

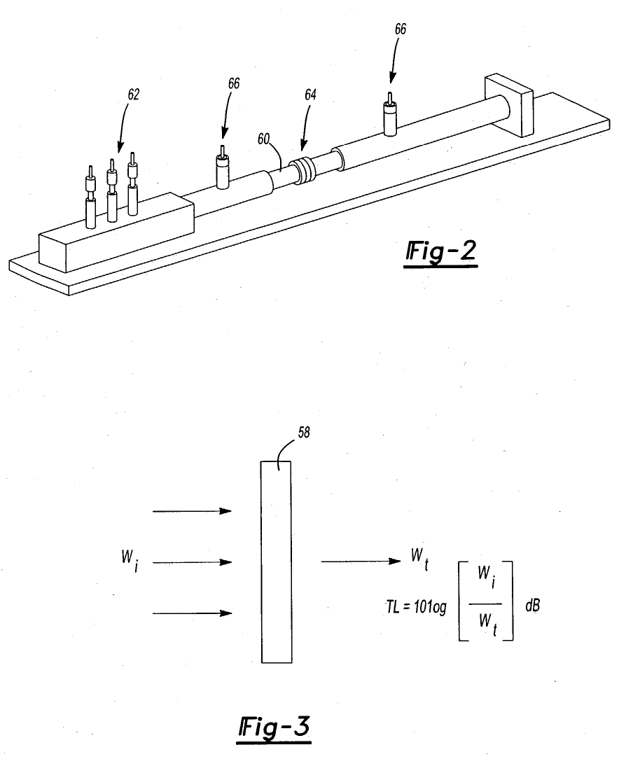

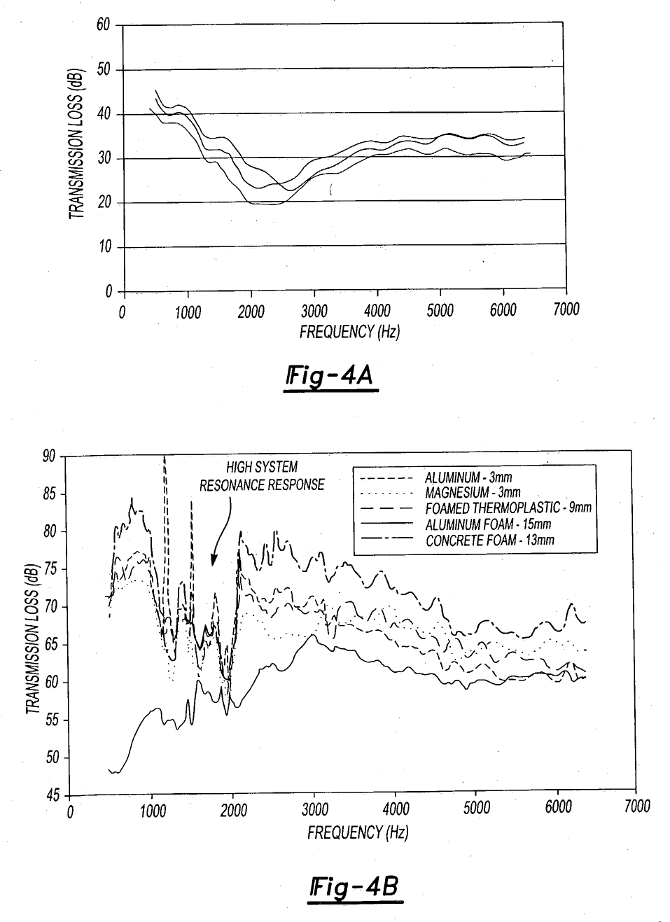

FIGS. 2 and 3 illustrates one approach to measuring performance of the present invention. An acoustical test is performed by placing a sample in a tube 60 that is located between a sound source 62 and a chamber 64 through which sound waves travels. One or more microphones 66 on either side of the sample measure the noise levels from the sound source 62. Transmission loss data can be obtained by analysis of the amount of sound energy decrease from source side to receiving side, and in accordance with FIG. 3. The absorption coefficient is a measure of the amount of sound energy dissipated by the system or sample. A higher absorption coefficient is desirable to reduce the possibility that the reflected sound is transmitted through another path and/or creating a system resonance response.

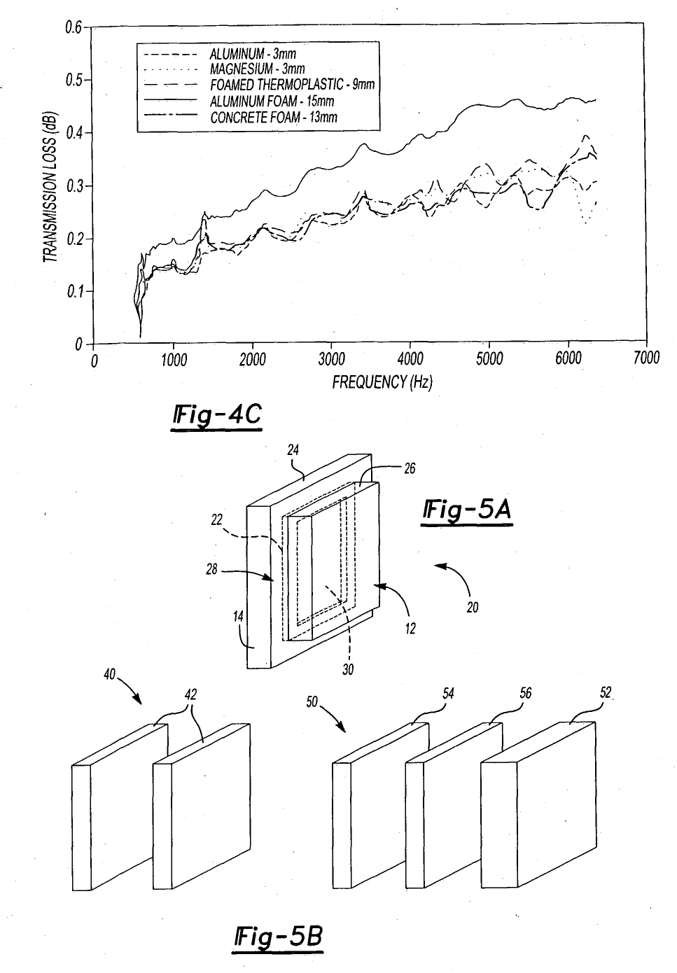

FIGS. 4a-4c illustrate results attainable using the individual materials identified herein. As shown in FIG. 4a, transmission losses for typical acoustic materials are below 50 dB over a frequency range of about 1000 Hz to about 7000 Hz. As shown in FIG. 4b, transmission losses for materials of the present invention are typically greater than 50 dB over the frequency range of about 1000 Hz to about 7000 Hz. Moreover, as shown in FIG. 4c, the materials of the present invention also typically exhibit relatively high absorption coefficients and particularly, aluminum foam exhibits an even higher absorption coefficient.

It will be appreciated that one of the novel features taught herein is the use of a layer of a metallic foam, and specifically an aluminum foam. Additional teachings for the use of metallic foams may be found in U.S. Pat. No. 6,094,798; and 6,135,542, hereby incorporated by reference. However, the foam may also be a titanium foam, a magnesium foam or another foam. It may also be a concrete foam. It may also be a mixture, laminate or composite of two or more of an aluminum foam, a titanium foam or a magnesium foam. It is further contemplated that the metal of the foam may be alloyed metals, pure metals or otherwise. It is even further contemplated that the foam may include a variety of materials such as various polymeric material, ceramic materials (e.g. ceramic particles), argon or any other synthetic or natural materials.

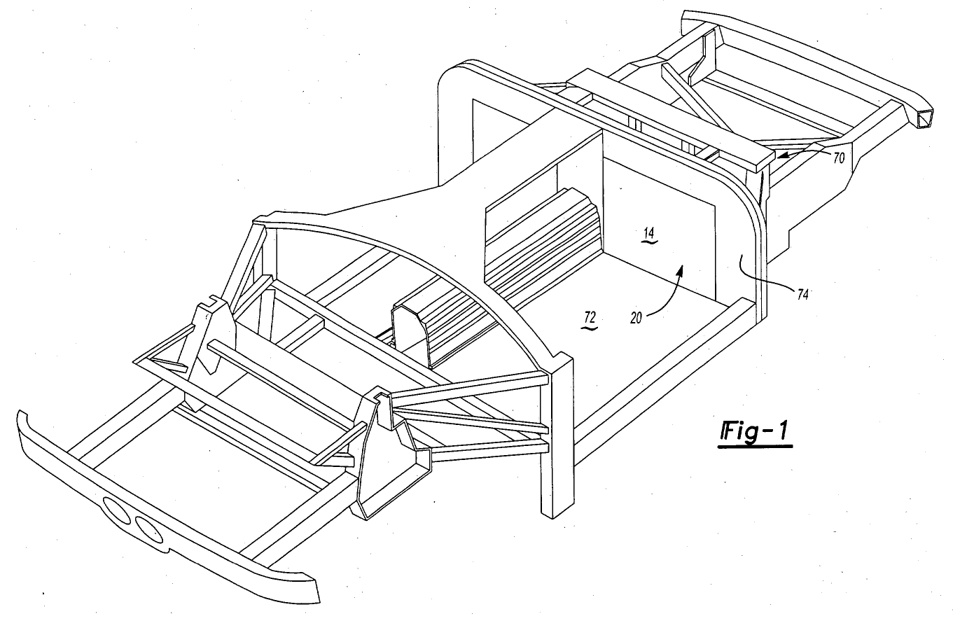

In one preferred application, and referring to FIG. 1, the structure 20 of FIG. 5a is employed as a reinforced vehicle bulkhead or midgate that is positioned between an engine compartment 70 and the passenger compartment 72 of an automotive vehicle. The bulkhead is preferably bonded to a metal frame 74 (e.g., an aluminum frame) of the vehicle. The entire bulkhead may be held in place by suitable mechanical fixtures (e.g., push pins, rivets (e.g., self piercing rivets) straps, clamps, pressure sensitive adhesive, fasteners or the like) during the e-coat process and subsequent bake. In turn, the adhesive 22 will expand and bond to the foam 12, the panel 14, the metal frame 74 or a combination thereof during exposure to elevated temperatures experienced during vehicle coating or painting steps, such as during an e-coat bake.

The use of such a decoupled structure (e.g., with aluminum foam on engine side, and a layer of solid aluminum on the passenger side) may permit for the elimination or reduction of insulation on the passenger side, allowing exposed aluminum to be used and an overall reduction of mass. Further, the use of insulation on the engine side can be reduced or even eliminated.

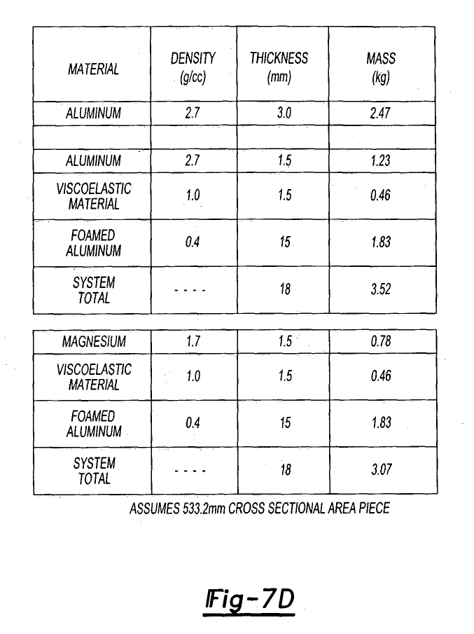

Illustrative data obtainable using the present invention is shown in FIGS. 7a-7f, it being recognized that performance data may fall within +/−80%, and more preferably within +/−50% of the amounts identified and still be within the present invention.

As can be seen with particular reference to FIG. 7b, the aluminum foam and the concrete foam exhibit relatively high absorption coefficients over the frequency range of about 1000 Hz to about 7000 Hz.

With reference to FIG. 7c, temperature differences across various panel structures at various thicknesses are shown for data taken using exposure to a 300° F. temperature or heat source 80 at one side 82 of the panels and exposure to a room temperature (e.g., about 72° F.) environment at the other side 84 of the panels. It can be seen that the aluminum foam and particularly the decoupled aluminum foam and the decoupled concrete foam exhibit relatively high heat insulation characteristics as compared to metal panels only. Moreover, such heat insulation characteristics begin to approach the heat insulation characteristics exhibited by conventional “firewall” types of insulation. As such, the panels and structures of the present invention may be used with substantially less, and potentially, without additional insulation.

With reference to FIG. 7d, mass measurements are shown for panels according to the present inventions. As such, the present invention contemplates weights of less than 2.0 grams per cm² of panel surface area, more preferably less than 1.5 grams per cm² of panel surface area and even more preferably less than 1.2 grams per cm² of panel surface area.

The present invention is applicable to a number of other applications including use in aircraft and in the applications discussed in “Recent Applications of Viscoelastic Damping for Noise Control in Automobiles and Commercial Airplanes”, by Mohan D. Rao, 2001 India-USA Symposium on Emerging Trends in Vibration and Noise Engineering, the contents of which are incorporated by reference.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

While a feature of the present invention may have been described in the context of only one or more illustrated embodiments, such feature may be combined with one or more other features of other embodiments, for any given application. It will also be appreciated from the above that the fabrication of the unique structures herein and the use thereof also constitute methods in accordance with the present invention.

It should also be understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. An improved damping or reinforcement structure for an automotive vehicle, comprising:
a wall of a first material;
a layer of metal foam opposing the wall of the first material; and
a layer of structural adhesive bonded to the wall and the layer of metal foam.

2. A structure as in claim 1 wherein the layer of adhesive separates the wall from the layer of metal foam such that a significant amount of open space is between the wall and the layer of metal foam.

3. A structure as in claim 2 wherein the layer of adhesive is applied as a continuous or non-continuous strip extending adjacent a peripheral edge of the wall or the layer of metal foam.

4. A structure as in claim 3 wherein the layer of adhesive substantially surrounds the open space.

5. A structure as in claim 1 wherein the adhesive is a heat expandable material.

6. A structure as in claim 1 wherein the structure thickness is no greater than 75 mm.

7. A structure as in claim 1 wherein the structure thickness is no greater than 50 mm.

8. A structure as in claim 1 wherein the wall and the layer of foam material are substantially coextensive with each other.

9. A structure as in claim 1 wherein the wall and the layer of foam material are located between a passenger compartment and an engine compartment of the automotive vehicle.

10. A structure as in claim 1 wherein the adhesive has a glass transition temperature greater than 70° C.

11. An improved damping or reinforcement structure for an automotive vehicle, comprising:
a panel formed of a first material, the first material being a metal;
a layer of foam material formed of a metal foam selected from magnesium foam and aluminum foam;
a viscoelastic adhesive that is bonded to the panel and the layer of foam material; and
a structural adhesive that is bonded to the panel and the layer of foam material wherein:
i) the structural adhesive is a heat expandable material; and
ii) the structure is located between a passenger compartment and an engine compartment of the automotive vehicle.

12. A structure as in claim 11 wherein the adhesive separates the layer of foam material from the panel and at least 50% of the space between the panel and the layer of foam material is filled by the viscoelastic adhesive.

13. A structure as in claim 12 wherein the structural adhesive is applied as a continuous or non-continuous strip extending adjacent a peripheral edge of the panel or the layer of metal foam.

14. A structure as in claim 13 wherein the structural adhesive substantially surrounds the viscoelastic adhesive.

15. A structure as in claim 11 wherein the structural adhesive is a heat expandable material.

16. A structure as in claim 11 wherein the structure thickness is no greater than 50 mm.

17. A structure as in claim 11 wherein the panel and the layer of foam material are substantially coextensive with each other.

18. A structure as in claim 11 wherein both the panel and the layer of foam material are located between the passenger compartment and the engine compartment of the automotive vehicle.

19. A structure as in claim 11 wherein the adhesive has a glass transition temperature greater than 70° C.

20. An improved damping or reinforcement structure for an automotive vehicle, comprising:
a panel of a first material, the panel having a thickness of between about 1.0 mm and about 2.0 mm, the first material being selected from aluminum, steel or magnesium;
a layer of viscoelastic adhesive bonded to the panel, the viscoelatic adhesive being thermally expandable from about 5% to about 2000% it original size at a temperature of 200° F. or greater, the layer of adhesive being between about 0.5 and about 2.0 mm thick; and
a layer of a metal foam bonded to the viscoelastic adhesive, the metal foam being selected from aluminum foam and magnesium foam, the layer of metal foam being between about 12 mm and about 15 mm thick;
wherein i) each of the panel, the layer of viscoelastic adhesive and the layer of metal foam are disposed between a passenger compartment of the automotive vehicle and an engine of the automotive vehicle, ii) the layer of foam is closer to the engine than the panel and iii) the reinforcement structure can be packaged for a thickness of no greater than 50 mm thick.
